(19) United States
(12) Patent Application Publication
(10) Pub. No.: US 2022/0274045 A1
(43) Pub. Date: Sep. 1, 2022

(54) DEVICE AND METHOD FOR CONTROLLING OIL/EMULSION MIST POLLUTION AND FUMES

(71) Applicant: GIFFIN, INC., AUBURN HILLS, MI (US)

(72) Inventor: ABRAHAM J. SALAZAR, LAKE ORION, MI (US)

(73) Assignee: GIFFIN, INC., AUBURN HILLS, MI (US)

(21) Appl. No.: 17/632,684

(22) PCT Filed: Aug. 6, 2020
(86) PCT No.: PCT/US2020/045153

§ 371 Date: Feb. 3, 2022

Related U.S. Application Data
(60) Provisional application No. 62/883,940, filed on Aug. 7, 2019.

(51) Int. Cl. B01D 50/20; B01D 46/46; B01D 45/16; B01D 46/62

(52) U.S. Cl. CPC B01D 50/20; B01D 46/46; B01D 45/16; B01D 46/62; B01D 2273/30

(57) ABSTRACT

An oil mist collector that is coupled to a machine to receive airborne oil mist generated by the machine. The oil mist collector includes a vortex scrubber in which oil mist particles in the airborne oil mist are removed from the air. The removed oil mist particles are collected and/or recycled back to the machine for reuse. Air from which the oil mist particles have been removed is exhausted through a HEPA filter. A method of removing oil mist particles from airborne mist generated by a machine involves the use of the oil mist collector.

### CROSS-REFERENCE TO RELATED APPLICATIONS

This PCT International Application claims the benefit of priority under 35 U.S.C. § 119 to U.S. Provisional Patent Application No. 62/883,940, filed Aug. 7, 2019, the contents of which are incorporated herein by reference in their entirety.

### FIELD OF THE INVENTION

The present invention generally relates to systems associated with oil emulsions used in commercial applications, including manufacturing processes. More specifically, the present invention relates to a device and method for controlling oil emulsion pollution and fumes in manufacturing process environments.

### BACKGROUND

Many commercial and industrial processes require the use of an oil emulsion. For example, modern computer numerical control (CNC) machining, wet grinders, as well as forming and pressing machines use oil emulsions to cool tools and molds and flush away debris in order to maintain production throughput and part quality. Other applications that use oil emulsions as water based lubricants and coolants include steel and aluminum rolling mills, tool and die processes, parts washers, food processing, packaging systems, asphalt operations and the like.

In many processes that involve the use of oil emulsions, the emulsions are sprayed and/or subjected to high temperatures which creates oil/emulsion mists of airborne oil particles. During use, millions of oil/emulsion mist particles are generated inside CNC machines, wet grinders, and forming and pressing machines. When left uncaptured, oil/emulsion mist creates poor indoor air quality in workshops which is a common problem around the world. These oil emulsion particles can be as small as bacteria and are harmful to humans. In particular, airborne oil mist is potentially dangerous to the lungs, larynx, eyes and skin.

In addition to creating health issues, oil emulsions creates safety issues. For example, oil mist creates slippery surfaces which increase accident rates. Such slippery surfaces are particularly dangerous around hazardous commercial and industrial processing machinery. Oil mist deposits also create potentially serious fire risks by allowing fires to spread quickly.

Appreciable cost savings can be achieved when oil emulsion coolants or just the oil components can be recycled for reuse instead of venting out airborne oil mist and polluting the atmosphere. Further, heating and cooling costs can be saved by releasing the oil-free conditioned air back into machine facilities rather than exhausting processed air outdoors. Cost savings can also be realized by reducing the need to frequently clean exposed surfaces by reducing the amount of airborne oil mist that might otherwise contaminate such surfaces.

Higher productivity can be achieved by reducing indoor facility pollution that increase worker absenteeism and lower morale. Such pollution caused by airborne oil mist can also foul contacts in electronic equipment, causing expensive downtime. Overall, such indoor pollution creates a haze and fouls light surfaces creating an unclean appearance and odor that can lower worker morale and adversely impact performance and productivity.

Both the Occupational Safety and Health Administration (OSHA) and the National Institute for Occupational Safety and Health (NIOSH) currently limit airborne oil mist to 5 mg/m³, and are expected to impose even more stringent limits in the future.

These recognized health concerns make industrial and commercial facilities more vulnerable to workman's compensation claims and litigation which can be extremely expensive.

Various systems and methods have been developed to collect oil mist with varying degrees of success. Media-type Filtration (MF) systems include a blower with several filters of varying efficiencies. In MF systems, contaminated air passes through a set of coarse-to-fine media filters. The first filter functions as a pre-filter while the last filter is typically made from a High Efficiency Particulate Air (HEPA) material. While MF systems are useful for collecting and removing dry contaminants from air, they are not well suited for filtering oil mist which can damage and clog media filters, necessitating excessive filter replacement and decreasing airflow which reduces efficiency and allows ambient unwanted oil mist to remain at undesired levels.

Hybrid-type Filtration (HF) systems are similar to MF systems, but include reusable metallic, plastic or ceramic filters as the first set of filters, the last stage of filters still being some type of HEPA filter. Grease, oil and moisture are captured on the surfaces of the reusable filters and are collected in channels configured in the filters. When dirty, the reusable filters can be removed and washed for reuse. In some cases, the design of the reusable filters allow for the draining of collected oil into a container or for recycle back as an oil emulsion for a processing machine. While HF systems overcome some of the limitations of the MF systems and are more suitable for collecting coolant mist and oil, the reusable filters typically cost more and have lower efficiency than media filters and are still susceptible to reductions in airflow rates as contaminants are collected on the surfaces of the filters.

Electrostatic precipitators (EPs) use a blower to draw mist and smoke particles past an ionizer, which imparts a positive charge to particulates in the airflow. The charged particles then pass across a series of alternatively like-charged and grounded collection plates. The particles are repelled by the like-charged plates and forced to the oppositely charged plates where they are collected and the filtered air is returned to the ambient environment. EPs are not efficient at collecting large particles which do not attain charges efficiently. For that reason, a coarse pre-filter is typically provided at the EP inlet. The efficiency of EPs drops dramatically as the collecting plates become covered with particles. Accordingly, in order to maintain efficiency, the collection plates must be cleaned often. Since the collected residue may be considered a hazardous waste, it must be disposed of by a certified waste handing company, which can add to the cost of using EPs. As the collection plates become full, arcing can occur. Such arching generates ozone which is linked to a variety of health problems including chest pain, coughing, throat irritation and congestion. Workers who are exposed to ozone can also experience reduced lung function and inflammation of the linings of their lungs. These potential dangers have prompted OSHA and the Environmental Protection Agency (EPA) to regulate worker exposure to ozone.

Oil mist collection systems can either be centralized or provided as discrete collection units. In centralized collection systems, the exhaust from several machines are ducted to a large oil mist filtration unit. The connecting ducts that deliver polluted air to the centralized collection systems tend to develop a grimy buildup of oil on their inner surfaces, which requires excessive down time to periodically clean and maintain. Faulty duct joints may allow polluted air to leak back into the shop environment. Centralized systems can encounter difficulties in recirculating captured oil back to the machines, especially when the composition of the oil emulsion is not compatible among machines. It can also be difficult to adjust the operation of centralized collection units to the needs of each machine, for example, when some machines are off, the collection system still needs to be run.

Discrete oil mist collection systems are smaller units that can be connected directly to the exhaust from each machine. Advantages of discrete oil mist collection systems over centralized systems include better efficiency to recirculate captured oil back to each specific machine, the ability to adjust operation and performance of discrete units for each machine, and avoiding the need for extensive ductwork that has to be cleaned and maintained periodically.

### SUMMARY OF PREFERRED EMBODIMENTS OF THE INVENTION

In accordance with the present invention an oil mist collector is provided that is coupled to a machine to receive airborne oil mist generated by the machine. The oil mist collector includes a vortex type scrubber in which oil mist particles in the airborne oil mist are removed from the air. The vortex scrubber can be used in a wet or dry configuration. Additional media type filters may be implemented. The removed oil mist particles are collected and/or recycled back to the machine for reuse. Air from which the oil mist particles have been removed is preferably exhausted through a HEPA filter. A method of removing oil mist particles from airborne mist generated by a machine involves the use of the oil mist collector as described herein which may be operated in accordance with a number of process control features.

### BRIEF DESCRIPTION OF THE DRAWINGS

FIG. 1 is a schematic view of a mist collector according to an embodiment of the present invention;

FIG. 2 is a schematic view of a dry collection embodiment of a mist collector according the present invention;

FIG. 3 is a schematic view of a wet collection embodiment of a mist collector according to the present invention; and

FIG. 4 is a schematic view of a control system according to an embodiment of the present invention.

### DETAILED DESCRIPTION

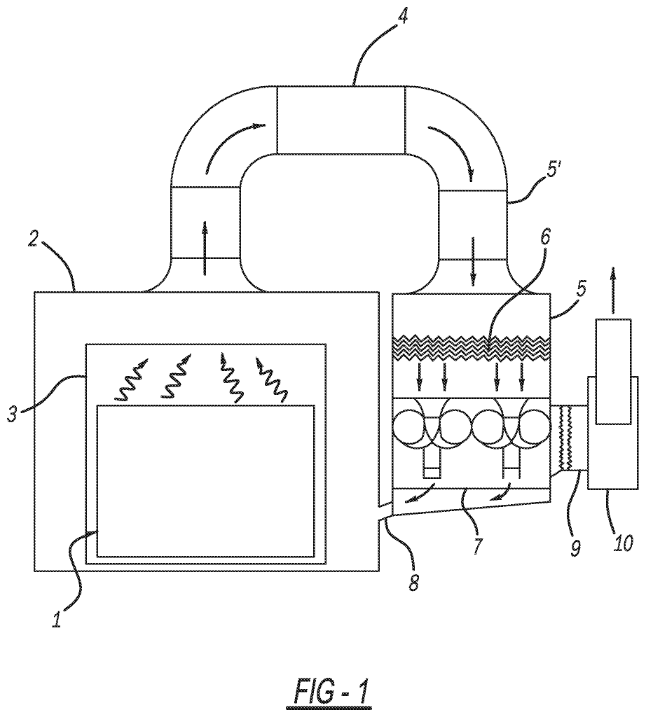

With reference to FIG. 1, reference numeral 1 represents an industrial or commercial processing operation or machine that, during operation, produces airborne oil mist from an oil emulsion that is fed into the processing operation or machine and used, for example as a lubricant and/or coolant. Examples noted above include CNC machining, wet grinders, forming and pressing machines, rolling mills, tool and die processes, parts washers, food processing, packaging systems, asphalt operations and others.

Reference numeral 2 identifies an enclosure or housing of the processing operation or machine, and reference numeral 3 identifies an access door to the processing or machining environment. Airborne oil mist produced by the processing operation is exhausted by the processing operation through duct 4 and is fed into inlet plenum 5′ of mist oil separator unit 5. The airborne oil mist passes through a pre-filter 6 that removes oversized particulates and flying debris from the machining process which are too large to be properly trapped by oil mist separator 5. The airborne oil mist then enters wet scrubber 7 that separates and collects oil from the oil mist produced in processing operation 2 and recycles the collected oil back into the processing operation via line 8 so that the recovered oil can be used to produce an oil emulsion lubricant and/or coolant for continuous processing. Flying debris is generated in the machining process and is composed of pieces or layers of the material being processed. If not captured by prefilter 6, such flying debris may be captured by the separator unit 5, clogging it and reducing its performance. Air from which oil mist particles have been removed is exhausted by exhaust fan 10 after passing through exhaust/post filter 9.

As mentioned above the embodiment illustrated in FIG. 1 utilizes a wet vortex type scrubber 7. Here “wet” is used to indicate that a volume of fluid medium, for example a liquid oil emulsion process fluid for the machine 1 is introduced into the inlet of scrubber 7 which helps to form a coalescing surface for oil mist and other particles. The collected liquid process fluid along with collected oil mist and particles are drained via line 8. Vortex type is used here to identify a scrubber unit which utilizes a cyclonic, circular or helical flow pattern used to separate out higher density particles utilizing a centrifugal effect. According to one embodiment, the present invention incorporates the use of a commercial vortex scrubber design available from Giffin, Inc. (Auburn Hills, Mich.), the assignee of the present application, and referred to as their ELITE™ scrubber which is encompassed by U.S. Pat. No. 8,241,405. This scrubber 19 design uses a vortex pair to classify and precipitate oil droplets towards its internal surface, where the oil either coalesces forming a running oil film (dry capturing) or is mixed into an emulsion stream (wet capturing). This scrubber is designed and configured to drain captured oil back to a reservoir, and is self-cleaning, so that virtually little or no maintenance is required during extended use. In the described embodiments of the present invention the vortex scrubber 19 can be used in a “wet” i.e. with the addition of a liquid fluid to the scrubber, or in a “dry” configuration i.e. without a secondary liquid fluid source.

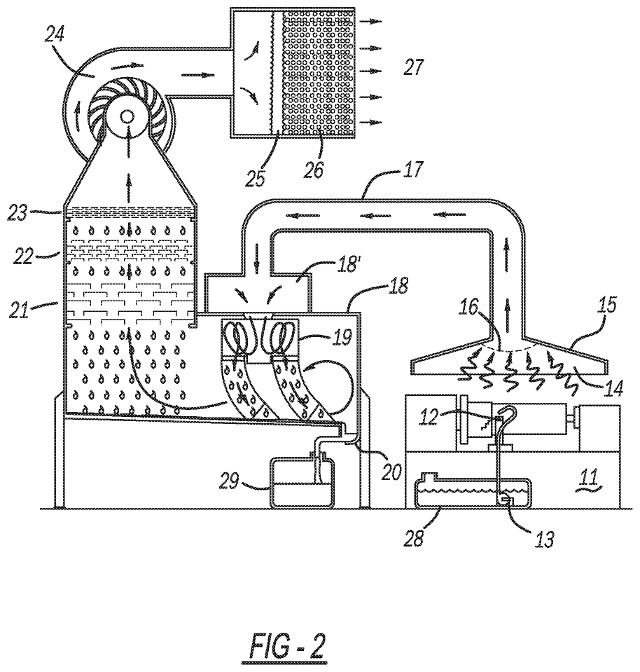

FIG. 2 is a schematic view of a dry collection embodiment of a mist collector according to one embodiment of the present invention. In FIG. 2 reference numeral 11 identifies a processing machine such as a CNC machine, wet grinder, lathe, etc. which uses an oil emulsion as a lubricant and/or coolant. Such a machine can include or be coupled to a reservoir 28 of oil emulsion and provided with an oil emulsion pump 13 that directs a spray of oil emulsion through nozzle 12 to a cutting tool, grinder, etc. for purposes of providing lubrication and cooling during a machining operation.

Airborne oil mist 14 produced by the processing machine 11 during operation is dragged into the airflow entering hood 15 and exhausted from the processing machine 11 through exhaust duct 17 after passing through pre-filter 16 that removes oversized particles and flying debris from the exhausted airborne oil mist 14. The exhaust duct 17 feeds the airborne oil mist into inlet plenum 18′ of oil separator unit 18. The airborne oil mist enters vortex scrubber 19 which separates oil from the airborne oil mist. Separated oil/water is collected at channel 20 and directed into collected oil container 29.

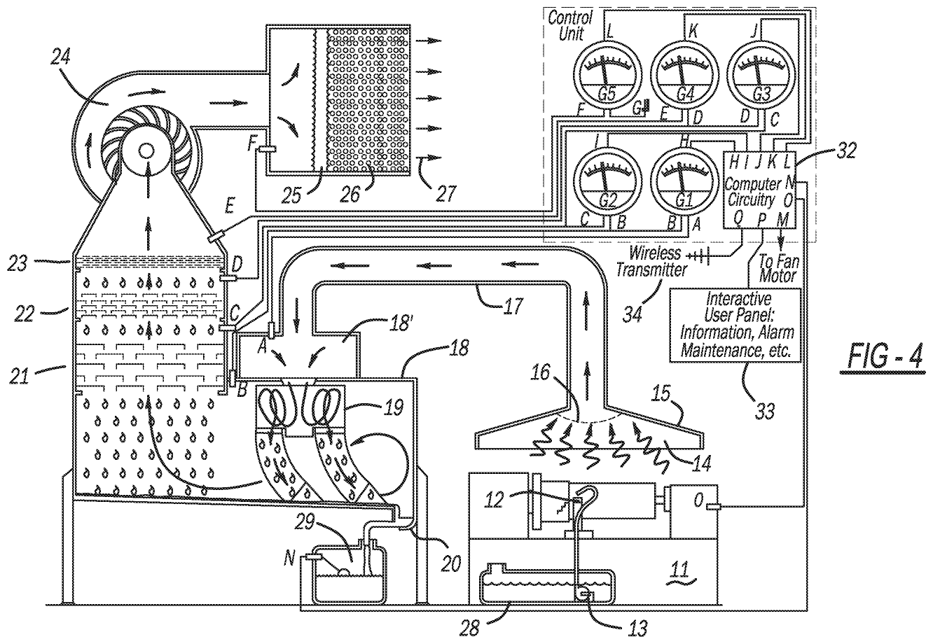

Air that passes through vortex scrubber 19 can pass through one or more optional coarse mist reusable filter 21, medium mist reusable filter 22 and fine mist reusable filter 23. Depending upon the efficiency of the vortex scrubber 19 to remove oil from the airborne oil mist, one or more of mist reusable filters 21, 22 and 23 can be used to capture and remove residual oil. Such mist reusable filters 21, 22 and 23 may be of the type used as metallic filters in the Hybrid-type Filtration (HF) systems discussed above and can be sized and configured to trap and collect oil mist particles of various sizes. However, other types of reusable filters may be used such as plastic, ceramics, etc. Any residual oil removed by optional mist reusable filters, if used, can drop onto a bottom portion of the oil separator unit 18 and be collected at channel 20 with the oil removed by the vortex separator 19. Alternatively, the oil removed by the optional reusable filter may be collected in a trough (not shown) and then drained into channel 20 and into reservoir 28. In this configuration the fluid flow direction is downwardly through vortex scrubbers 19 and then turns to flow in an upward direction to media filters 21, 22 and 23, as indicated by the flow arrows in FIG. 2 (as well as in FIGS. 2 and 4). Such upward flow direction promotes further separation of the airborne oil mist since it tends to fall downwardly due to its density and the influence of gravity. Such downward flow of the airborne oil mist as a coalesced liquid is indicated by the droplets in the figures. The collected airborne oil mist falls to the bottom of separator unit 18 where it is collected and retained or reused by the processing machine 11.

A suitable fan 24 exhausts air 27 from the oil separator unit 18 through an optional odor filter 25 of conventional design and a HEPA filer 26.

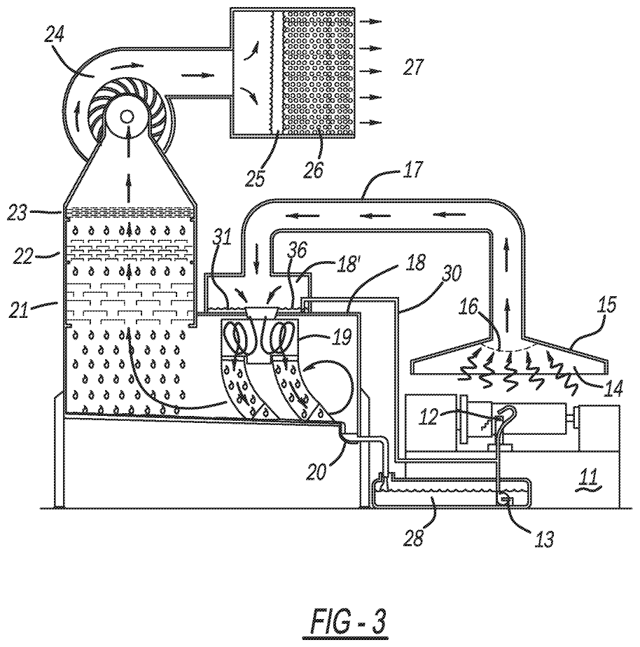

FIG. 3 is a schematic view of a wet collection embodiment of a mist collector according to one embodiment of the present invention. The wet collection embodiment of the mist collector of FIG. 3 includes many of the same elements as the dry collection embodiment of the mist collector of FIG. 2. Accordingly, corresponding elements are identified with the same reference numerals in both figures. A significant main difference between the dry collection embodiment and the wet collection embodiment is that in the wet collection embodiment, the inlet plenum 18′ includes a flooded emulsion pan 31 having a collected quantity of the process fluid 36 from the machine 1. Emulsion from reservoir 28 is supplied to the flooded emulsion pan 31 through line 30. The emulsion supplied to the flooded emulsion pan 31 creates a flowing emulsion film on the internal surfaces of the vortex scrubber 19. Oil particles in the airborne oil mist feed entering vortex separator 19 impinge and become entrapped in the flowing emulsion film by the action of impaction and centrifugal acceleration inside vortex scrubber 19. The emulsion film flow inside the scrubber 19 is generated by the emulsion supplied to the flooded emulsion pan 31 that flows into the inlet of the vortex scrubber 19.

In the dry collection embodiment of the mist collector described in reference to FIG. 2 above, no extensive modification is needed to retrofit the collector for use with existing processing machines. One merely needs to couple the inlet plenum 18′ to the existing air duct of a processing machine. The dry collection embodiment can incorporate one or more vortex scrubbers that use a vortex and impact surfaces to coalesce oil mist particles into a film. The collected (or captured) oil is recovered and/or recycled as desired.

In the wet collection embodiment of the mist collector described in reference to FIG. 3, only minimum modification is needed to retrofit the collector for use with existing processing machines. One merely needs to couple the inlet plenum 18′ to the existing air duct of a processing machine to add an emulsion feed line to supply emulsion to the flooded emulsion pan 31 which receives and retains a collected volume of the liquid process fluid for the machine. As in the dry collection embodiment, the wet collection embodiment can incorporate a plurality of vortex scrubbers 19 that uses a fluid vortex to precipitate oil mist particles into a flowing emulsion film and impact surfaces to coalesce airborne oil mist particles into a running film. The oil mist is captured into the emulsion and the mixture is recycled back to the machine. Since the amount of oil mist captured into the emulsion film by vortex separator 19 is considerably small in comparison with the amount of flowing emulsion, it is expected that the captured oil mist will emulsify upon contact with the running emulsion film, especially because of the enhanced mixing promoted by the turbulence inside vortex scrubber 19.

The oil mist collectors of the present invention can be used as discrete units that are paired to individual machines.

While FIGS. 2 and 3 depict and are described as using vortex scrubbers 19, such scrubbers are exemplary in nature and not intended to limit the application of the present invention. As persons skilled in the technology will appreciate, the principles of the present invention are equally applicable to any non-vortex wet scrubbers, as well as to other applications where the capturing of airborne particulates is desired or required.

The use of optional coarse-to-fine reusable filters 21, 22 and 23 discussed above would only be needed to collect and handle small droplets that penetrate or pass through the wet scrubber 19. Therefore, such reusable filters would only foul infrequently, reducing maintenance requirements when used. Such optional reusable filters can be designed to drain captured oil into a container, and/or recycle captured oil back to the original machine, avoiding situations that may occur in centralized collection units, in which the coolant mix captured from several machines may be incompatible between the different machines and therefore not suitable to be recirculated back.

Since mass penetration is multiplicative, it has been determined that a scrubber rated for example at 99.9% efficiency (0.1% penetration=0.001), combined with two optional reusable filters rated for example at 85% efficiency each (15% penetration=0.15), would provide a combined penetration of 0.001×0.15×0.15=0.0000225 (0.00225%). In such a case, for example, if 80 gal/yr of oil enter the separator 19, only 0.0018 gal/yr=1.3824 tsp/yr would reach the exhaust fan 24. Even less than this amount would reach the odor filter 25 and the HEPA filter 26 should not see practically any particulates.

The odor filters 25 would receive only those particles that are so small as to penetrate the scrubber, the optional reusable filters and fan 24. Accordingly, the odor filters 25 would receive almost no particulates and should foul very infrequently. Therefore, filter changes will be reduced to a minimum, reducing operational cost as compared to prior art use of similar filters in commercial systems. Infrequently fouling filters also means that the airflow rate of the mist collector 18 of the present invention is expected to remain virtually constant.

Fans with integrated control systems which adjust fan speed, can be used to make sure the system collectors airflow rate remains constant to maintain desired capturing performance. Minimal modification to existing machines is needed to attach the oil mist collection units of the present invention.

Airflow rate of the oil mist collectors depends on machine size. Accordingly, the oil collector units of the present invention can be scaled up as needed to handle a range of airflows while retaining capturing efficiency. Otherwise, for larger required airflow rates, any necessary rate can be achieved just by increasing the number of oil mist collectors that are used together.

FIG. 4 is a schematic view of a control system according to one embodiment of the present invention. The control system shown in FIG. 4 is incorporated into a dry collection embodiment of a mist collector according to one embodiment of the present invention for descriptive purposes, it being understood that a similar control system could also be used in conjunction with a wet collection embodiment of a mist collector of the present invention.

The control system includes pressure sensor A, provided in inlet plenum 18, pressure sensor B, provided downstream of scrubber 19 and upstream of optional coarse mist reusable filter 21, pressure sensor C, provided downstream of optional coarse mist reusable filter 21 and upstream of optional medium mist reusable filter 22, pressure sensor D, provided downstream of optional medium mist reusable filter 22 and upstream of optional fine mist reusable filter 23, pressure sensor E, provided downstream of optional fine mist reusable filter 23 and upstream of the exhaust fan 24, pressure sensor F, located downstream of the exhaust fan 24 and upstream of optional odor filter 25, and pressure sensor G that is provided to measure ambient pressure. Pressure sensor ports can be provided in the listed areas to allow for installation, replacement and removal of each of the pressure sensors.

Pressure sensors A and B are used to determine the differential pressure across scrubber 19 and display the pressure differential on differential pressure gage G1. Pressure sensors B and C are used to determine the differential pressure across optional coarse mist filter 21 and display the pressure differential on differential pressure gage G2. Pressure sensors C and D are used to determine the differential pressure across optional medium mist filter 22 and display the pressure differential on differential pressure gage G3. Pressure sensors D and E are used to determine the pressure differential across optional fine mist filter 23 and display the pressure differential on differential pressure gage G4. Pressure sensors F and G are used to determine the pressure differential across the optional odor and HEPA filters, 25, 26, and display the pressure differential on differential pressure gage G5. These values may be used to control operational variables for the mist oil separation unit 5 or could be used to create alarms or warnings for checking or replacing media elements.

In addition to the pressure sensors A-G, a fluid level sensor N can be provided in reservoir 28 to monitor the level of oil emulsion in reservoir 28. Further, a machine operating sensor O can be provided to determine when the processing machine 11 is operating.

Control unit 32, having suitable computer programmable and processing circuitry, receives differential pressure signals H-L from differential pressure gages G1-G5 respectively, and sends an appropriate control signal M to the motor of exhaust fan 24.

By comparing the differential pressure signals H-L to preset, predetermined or calibrated reference values, the programmable circuitry of control unit 32 can diagnose individual components of the mist collection system and determine if any component needs attention and/or maintenance.

The programmable circuitry of control unit 32 can include program routines that analyze signals from the various sensors provided in the mist collector and display: a) appropriate operation information; b) status of each component; c) warnings to indicate that a component requires attention and/or is no longer operating within specifications; and d) alarms to indicate that a component is no longer operating correctly, as well as: e) set the mist collector on stand-by mode; f) stop the operation of the mist collector to avoid any damage; etc. An interactive user panel 33 is provided for user input and displaying operational information, alarms, maintenance requirements, etc.

The programmable circuitry of control unit 32 can further be programmed to: a) respond to a signal from machine operating sensor O and direct the mist collector to run only when machine is in operation, saving energy; b) respond to a signal from the fluid level sensor N and signal an alarm if the level of oil emulsion in reservoir 29 is full and needs to be emptied, or signal an alarm if there is not enough of a supply of oil emulsion in reservoir 29 to operate (wet capturing only); and c) adjust the operation of the fan motor to maintain airflow rate, compensating for components that are fouling (e.g., the optional reusable filters). Here it is noted that while airflow rate through the collector could be detected using an airflow meter, since pressure drop through the scrubber correlates with airflow rate (for any given emulsion flow rate), adjusting the exhaust fan motor to maintain a pre-set differential pressure across the scrubber 19 (signal H), is equivalent to maintaining the airflow rate, eliminating the need for a dedicated airflow meter.

As noted above the control system depicted in FIG. 4 can be used to control the operation of a mist collector for either a dry mist collection embodiment (in which oil is coagulated into an oil film) or a wet mist collection embodiment (in which oil is captured into an emulsion stream). It is also understood that in addition to the various sensors mentioned and described above additional sensors as well as different types of sensors could be included if desired to monitor other operational features.

The control system of the present invention can communicate via wireless type communication protocols using transmitter 34 to send messages to responsible personnel about the status, warnings, alerts, etc., of the mist collection system.

The embodiments described above were chosen to provide the best application to thereby enable one of ordinary skill in the art to utilize the disclosed inventions in various embodiments and with various modifications as are suited to the particular use contemplated. All such modifications and variations are within the scope of the invention.

1. An oil mist collection unit for receiving an airborne oil mist from a machine, the oil mist collection unit comprising:
a housing configured to be coupled to the machine for receiving the airborne oil mist from the machine;
a vortex scrubber within the housing into which the airborne oil mist generated by the machine is fed, the vortex scrubber separating oil mist particles from the airborne oil mist creating separated oil mist particles;
a container for collecting the separated oil mist particles, and
an exhaust system for exhausting air from the oil mist collector from which the separated oil mist particles have been removed.

2. An oil mist collector according to claim 1, wherein the scrubber comprises the vortex scrubber implemented in a wet configuration with a volume of a process fluid for the machine provided to an inlet of the vortex scrubber.

3. An oil mist collector according to claim 1, further comprising a one or more media filters through which air is exhausted from the exhaust system to act as a downstream filter from the vortex scrubber for further removing the oil mist particles from the air.

4. An oil mist collector according to claim 3, further comprising the one or more media filters are reusable filters.

5. An oil mist collector according to claim 3, further comprising the one or more of the media filters includes an odor filter or a HEPA filter.

6. An oil mist collector according to claim 3, further comprising a flow of air containing the airborne oil mist flows in a downward direction through the vortex scrubber and after flowing through the vortex scrubber flows in an upward direction through the one or more media filters.

7. An oil mist collector according to claim 1 further comprising the airborne oil mist produced by the machine is generated from a process fluid for the machine and wherein the separated oil mist is consolidated and provided to the machine for further use as the process fluid.

8. An oil mist collector according to claim 7, further comprising a recycle line for returning the separated oil mist particles back to the machine as the process fluid.

9. An oil mist collection unit according to claim 1, further comprising a control system that includes at least one first sensor for determining a pressure differential across the vortex scrubber and at least one second sensor for determining a pressure differential across the exhaust system.

10. An oil mist collection unit according to claim 9, wherein the control system further comprises a sensor for detecting operation of the machine and the control system controlling the operation of the oil mist collection unit based on the operation of the machine.

11. A method of removing oil mist particles from airborne oil mist generated by a machine, the method comprising the steps of:
receiving the airborne oil mist generated by the machine;
separating oil mist particles from the airborne oil mist in a four tax scrubber;
collecting the separated oil mist particles; and
exhausting air from the oil mist collector from which the oil mist particles have been removed.

12. A method of removing oil mist particles from airborne mist generated by a machine according to claim 11, wherein the separated oil mist particles are recycled back to the machine.

13. A method of removing oil mist particles from airborne mist generated by a machine according to claim 11, further comprising filtering the air after flowing through the vortex scrubber through one or more reusable filters.

14. A method of removing oil mist particles from airborne mist generated by a machine according to claim 11, further comprising:
monitoring a pressure differential across the scrubber and a pressure differential from the scrubber to where air is exhausted from the oil mist collector; and
controlling operation of the oil mist collector based on the monitored pressure differential across the scrubber.

15. A method of removing oil mist particles from airborne mist generated by a machine according to claim 14, wherein the operation of the oil mist connector is controlled by controlling a fan that causes air to be exhausted from the oil mist collector.
